(19) United States
(12) Patent Application Publication
(10) Pub. No.: US 2010/0142587 A1
(43) Pub. Date: Jun. 10, 2010

(54) TEMPERATURE MEASUREMENT CIRCUIT

(76) Inventor: MIKIHIRO KAJITA, Tokyo (JP)

Correspondence Address: Mr. Jackson Chen, 6535 N. STATE HWY 161, IRVING, TX, 75039, US

(21) Appl. No.: 12/624,190

(22) Filed: Nov. 23, 2009

(30) Foreign Application Priority Data
Dec. 9, 2008 (JP) 2008-312908

(51) Int. Cl. G01K 7/00

(52) U.S. Cl. 374/183; 374/E07.001

(57) ABSTRACT

A temperature measurement circuit includes a diode including a pair of terminals between which a constant voltage is applied and passing therethrough a current that changes depending on a temperature; and a temperature detection section that detects the temperature based on the current passing through the diode. The temperature measurement circuit measures the temperature with a higher accuracy.

This application is based upon and claims the benefit of priority from Japanese patent application No. 2008-312908 filed on Dec. 9, 2008, the disclosure of which is incorporated herein in its entirety by reference.

### TECHNICAL FIELD

The present invention relates to a temperature measurement circuit and, more particularly, to a temperature measurement circuit that includes an electronic device passing therethrough a current that varies depending on the ambient temperature thereof. The present invention also relates to a semiconductor device including such a temperature measurement device, and a method using the electronic device.

### BACKGROUND ART

Recently, it has become a crucial issue to control generation of heat in an LSI (large scale integrated) chip, such as a microprocessor. If the electric power is not controlled for reduction thereof in the LSI in accordance with the ambient temperature, the cooling performance may be insufficient to cause an excessive temperature rise in the LSI. The excessive temperature rise may sometimes degrade the reliability of the LSI. This problem is more crucial in the LSIs of advanced generation that have smaller dimensions.

In order to avoid the above problem, it is needed to monitor the junction temperature within the LSI, and to perform a suitable operation or processing depending on the result of the monitoring. As an example for the technique for handling the problem of temperature rise, a throttle-ring technique is presented by IBM in the international ISSCC 2004 conference. In this technique, if the temperature exceeds a specific threshold, control is performed to reduce the rate of issuance of commands. Reduction in the rate of command issuance reduces the operating speed of the LSI to thereby prevent the temperature rise that exceeds the crucial temperature.

In order to realize the above control in the LSI, it is needed to install therein a temperature measurement circuit. The temperature measurement circuit should achieve a sufficient accuracy and have a smaller occupied area that allows a variety of LSIs to install therein the temperature measurement circuit.

Patent Publication-1 describes an overheat detection circuit used as the temperature measurement circuit. FIG. 6 shows the principle of the overheat detection circuit described in Patent Publication-1. A temperature-detecting diode 211 changes the forward voltage drop thereof in accordance with a temperature change. The temperature-detecting diode 211 is connected to a current source 212 in a forward direction, to thereby pass a constant current. The voltage between both the terminals of the temperature-detecting diode 211, which passes therethrough the constant current, is measured to calculate the ambient temperature based on the temperature-voltage characteristic of the diode 211.

The temperature detecting techniques other than that measuring the voltage between both the terminals of the diode include ones described in Patent Publications-2 and -3. The technique described in Patent Publication-2 uses a current mirror circuit and monitors the temperature-dependent current of a transistor that passes through the measurement-targeted node, while replacing the current with another current passing through another transistor. The technique described in Patent Publication-3 probes a temperature-dependent current of a resistor used for the measurement, to detect the temperature change based on the current change.

The list of Patent Publications as described above is as follows:

Patent Publication I—JP-2003-294542A;

Patent Publication 2—JP-2002-289789A; and

Patent Publication 3—JP-1984-204729A

The following is the analysis conducted by the present inventor. In order to detect the ambient temperature with a higher accuracy in the circuit configuration shown in FIG. 6, it is needed to supply an accurate constant current from the current source 212. However, there is a parasitic resistance existing in the temperature-detecting diode 211 and interconnections, whereby the current generated by the current source 212 may pass through the parasitic resistance as a branch current. This means there is a possibility that the current source 212 does not function as the accurate current source with respect to the temperature-detecting diode 211. Moreover, the resistance in the circuit changes depending on the ambient temperature, whereby the temperature-dependent change of the resistance incurs an error in the detected temperature. For correcting this error, it is needed to employ dedicated circuit elements in the temperature measurement circuit, to thereby increase the circuit scale.

In the circuit described in Patent Publication-2, transistors used therein configure a current mirror. The current mirror generally requires an equal characteristic for the constituent transistors that form a pair. However, in the LSI of the advanced generation having smaller dimensions, transistors configuring the current mirror do not have necessarily the same characteristic, thereby incurring the problem of inaccuracy in the detected temperature. As to the technique described in Patent Publication-3, the resistor elements having smaller dimensions in the LSI of advanced generation generally have a significant range of variation in the resistance, thereby causing an error in the detected temperature. Moreover, generation of heat in the resistor elements may exert a significant influence on the detected temperature.

### SUMMARY OF THE INVENTION

In view of the above, it is an object of the present invention to provide a temperature measurement circuit that is capable of measuring the temperature with a higher accuracy and without an increased circuit scale, a semiconductor integrated device (LSI) that includes such a temperature measurement circuit, and a method used in such a circuit and a device.

The present invention provides a temperature measurement circuit including: a diode including a pair of terminals between which a constant voltage is applied, the diode passing therethrough a current that changes depending on a temperature; and a temperature detection section that detects the temperature based on the current passing through the diode.

The present invention also provides a semiconductor integrated circuit including: a diode including a pair of terminals between which a constant voltage is applied, the diode passing therethrough a current that changes depending on a temperature; a temperature detection section that detects the temperature based on the current passing through the diode; and a comparator that compares the temperature detected by the temperature detection section with a specific threshold temperature, to output a signal representing whether or not the temperature detected by the temperature detection section exceeds the threshold temperature.

The present invention further provides a temperature measurement method including: applying a constant voltage to a diode passing therethrough a current that changes depending on a temperature; and detecting the temperature based on the current passing through the diode.

The above and other objects, features and advantages of the present invention will be more apparent from the following description, referring to the accompanying drawings.

### BRIEF DESCRIPTION OF THE DRAWINGS

FIG. 1 is a block diagram showing a temperature measurement circuit according to a first embodiment of the present invention.

FIG. 2 is a graph showing the voltage-current characteristic of a diode.

FIG. 3 is a waveform diagram showing waveforms in the temperature measurement circuit of FIG. 1.

FIG. 4 is a block diagram showing an LSI according to a second embodiment of the present invention.

FIG. 5 is a waveform diagram showing waveforms in the LSI of FIG. 4.

FIG. 6 is a circuit diagram showing the principle of the overheat detection circuit described in Patent Publication-1.

### DESCRIPTION OF EXEMPLARY EMBODIMENTS OF THE INVENTION

Before describing exemplary embodiments of the present invention, the principle of circuit configuration of the present invention will be described. The temperature measurement circuit of the present invention includes, as a minimum configuration thereof: a diode including a pair of terminals between which a constant voltage is applied, the diode passing therethrough a current that changes depending on a temperature; and a temperature detection section that detects the temperature based on the current passing through the diode.

The LSI of the present invention includes, as a minimum configuration thereof: a diode including a pair of terminals between which a constant voltage is applied, the diode passing therethrough a current that changes depending on a temperature; a temperature detection section that detects the temperature based on the current passing through the diode; and a comparator that compares the temperature detected by the temperature detection section with a specific threshold temperature, to output a signal representing whether or not the temperature detected by the temperature detection section exceeds the threshold temperature.

The temperature measurement method of the present invention includes, as a minimum configuration thereof: applying a constant voltage to a diode passing therethrough a current that changes depending on a temperature; and detecting the temperature based on the current passing through the diode.

In the temperature measurement circuit, semiconductor integrated device and method of the present invention, a constant voltage is applied between both the terminals of the diode passing therethrough a current that changes depending on the temperature of the diode, and the temperature of the diode is detected based on the current passing through the diode. In this configuration, an accurate constant voltage is generally obtained more easily than an accurate constant current, whereby configuration of the present invention can measure an accurate temperature than the technique that includes passing a constant current through the diode and measuring the voltage appearing between both the terminals of the diode.

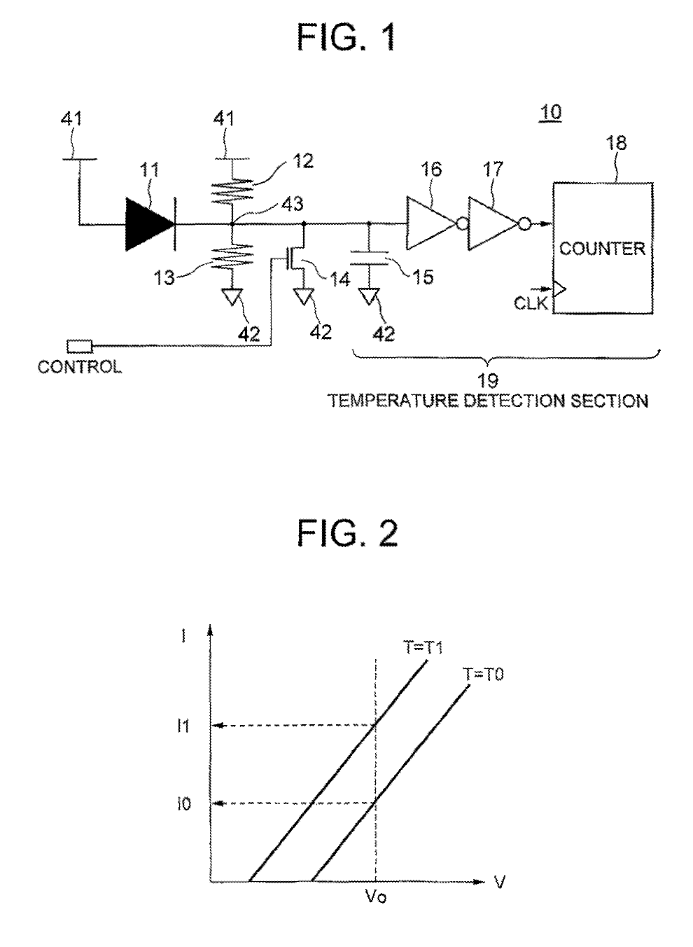

Now, exemplary embodiments of the present invention will be described with reference to accompanying drawings, wherein similar constituent elements are designated by similar reference numerals throughout the drawings. FIG. 1 shows a temperature measurement circuit according to a first exemplary embodiment of the present invention. The temperature measurement circuit 10 includes a diode 11, resistors 12 and 13, a transistor 14, a capacitor 15, inverters 16 and 17, and a counter 18.

Resistors 12 and 13 are connected in series with each other between a high-potential power-source line 41 and a low-potential power-source line 42. The potential of a node connecting together resistors 12 and 13, i.e., the potential dividing the potential difference between the power-source line 41 and the power-source line 42 by the resistors 12 and 13 is referred to as potential 43. The potential 43 is substantially maintained at a constant potential even if the resistors 12 and 13 have a significant range of variation in the resistance thereof. More specifically, even if the resistors have a range of variation in the resistance thereof, it is likely that the range of variation assumes the same tendency, i.e., increasing or decreasing tendency, and substantially at the same rate with respect to the temperature change. Moreover, the resistors have a substantially same change rate in the resistance with respect to the temperature range.

The diode 11 is connected between the power-source line 41 and the node (potential 43) connecting together the resistors 12 and 13. Since each of the potentials of power-source line 41 and the potential 43 is a constant potential, the voltage applied between both the terminals of the diode 11 is constant. The diode 11 is a PN junction diode, which has a voltage-current characteristic in the forward direction that changes depending on the temperature change.

FIG. 2 shows the voltage-current characteristic of the diode 11 obtained during application of a forward voltage thereto. More specifically, FIG. 2 shows the voltage-current characteristics for a temperature of T0 and a higher temperature of T1. If the voltage applied between both the terminals of the diode 11 is Vo, the current passing through the diode at the temperature T0 is 10, whereas the current passing through the diode at the higher temperature T1 increases up to 11. In this way, the current passing through the diode, with the applied voltage being maintained constant, changes depending on the temperature. Thus, it is possible to detect the temperature by measuring the current passing through the diode 11.

The transistor 14, capacitor 15, inverters 16 and 17, and counter 18 in association configure a temperature detection section 19 that detects the temperature based on the current passing through the diode 11. Both the transistor 14 and capacitor 15 are connected between the cathode of diode 11 and the power-source line 42 (GND). Inverter 16 has an input terminal connected to the capacitor 15 and an output terminal connected to the input of inverter 17. The output terminal of inverter 17 is connected to the counter 18, which counts up based on the output of inverter 17.

An NMOS (N-channel metal-oxide-semiconductor) transistor is used for the transistor 14. The transistor 14 is a switching device that is controlled for ON/OFF operations based on the signal input to the control terminal thereof. The transistor 14 is controlled to assume an ON state before the start of temperature measurement. In this state, the current passing through the diode 11 passes to the power-source line 42 (GND) via the transistor 14. The transistor 14 is switched from the ON sate to assume an OFF state upon start of the temperature measurement. After the turn OFF of transistor 14, the current passing through the diode 11 passes into the capacitor 15 for charging the capacitor 15.

Each of the inverters 16 and 17 outputs an inverted signal of the input level. If the voltage of the capacitor 15 exceeds a threshold voltage Vt of inverter 16 as the result of charge up of the capacitor 15, the logic output of inverter 16 is reversed from “1” (or H-level) to “0” (or L-level). In response thereto, the logic output of inverter 17 is reversed from “0” to “1”. The counter 18 counts up by clock pulses until the output logic of inverter 17 assumes “1” since the turn OFF of the transistor 14. More specifically, the counter 18 counts the time length until the voltage of capacitor 15 exceeds the predetermined threshold voltage Vt since the start of charge up of the capacitor 15.

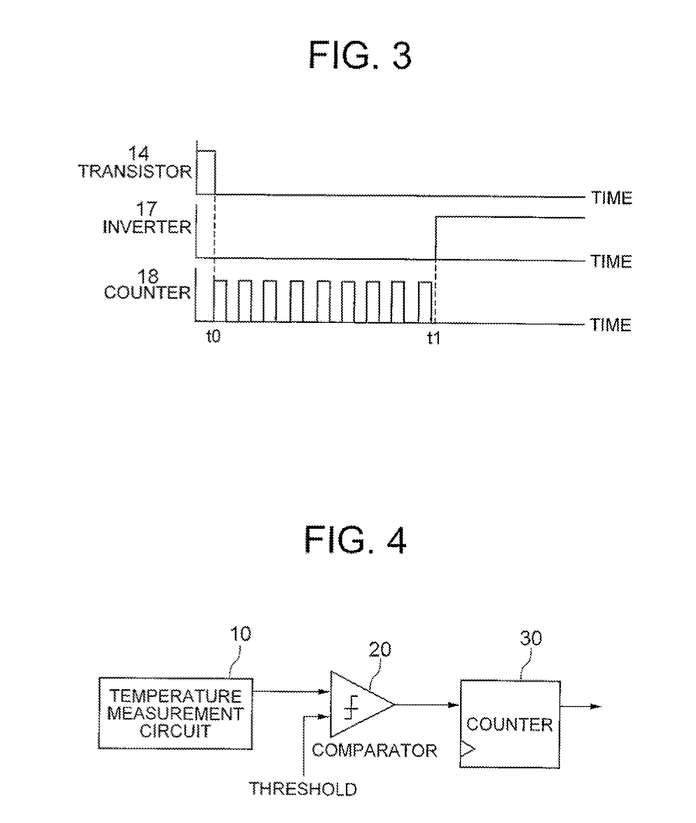

FIG. 3 shows a waveform diagram showing waveforms in the temperature measurement circuit. At time instant t0, the gate potential of transistor 14 falls to a zero volt, to turn OFF the transistor 14 and thus start charge up of the capacitor 15. At this stage, inverter 17 delivers an output logic of “0”. The counter 18 counts up based on a clock signal CLK. At time instant t1, the voltage of capacitor 15 exceeds the threshold voltage Vt of inverter 16, to thereby raise the output of inverter 17 toward “1”. The counter 18 outputs the count thereof counted from time instant t0 to time instant t1.

The time length from the turn OFF of transistor 14 to the rise of logic output of inverter 17 to “1” is determined by the charging current of capacitor 15. Since the charging current of capacitor 15 that passes through the diode 11 changes depending on the ambient temperature, the count of counter 18 changes in accordance with the change of current that passes through the diode 11. The temperature measurement circuit 10 outputs the count of counter 18 as the result of temperature measurement.

In the present exemplary embodiment, a constant voltage is applied between both the terminals of the diode 11 that passes therethrough a current depending on the ambient temperature of the diode 11, to detect the temperature based on the current passing through the diode 11. Application of the constant voltage between both the terminals of the diode 11 is significantly easier than passing a constant current through the diode 11. Moreover, the range of variation in the voltage applied between both the terminals of the capacitor depending on the temperature change is significantly lower than a range of variation in the current passing through the diode 11 depending on the temperature change. In the present exemplary embodiment, a higher resistance for the temperature change and variation of the devices configuring the temperature measurement circuit 10 is obtained, whereby it is possible to obtain an accurate temperature measurement even in the LSIs of advanced generation having smaller dimensions. Moreover, it is not needed to use dedicated circuit elements that correct the error, and thus it is possible to detect the temperature with a higher accuracy and without an increased circuit scale.

Next, a semiconductor integrated circuit (LSI) including the temperature measurement circuit 10 of the first embodiment will be described with reference to FIG. 4 showing a second exemplary embodiment of the present invention. The LSI includes the temperature measurement circuit 10 shown in FIG. 1, a comparator 20, and another counter (second counter) 30. The comparator 20 compares the result of temperature measurement by the temperature measurement circuit 10 with a predetermined threshold (threshold temperature). The comparator 20 outputs a signal that represents whether or not the result of temperature measurement is above the predetermined threshold, based on the result of comparison. The second counter 30 counts the time length during which the result of comparison by the comparator 20 represents that the measurement temperature is above the threshold.

The comparator 20 compares the count output from the counter (first counter) 18 of the temperature measurement circuit 10 with the threshold corresponding to the predetermined temperature. The comparator 20 outputs “0” if the count of the first counter 18 is smaller than the threshold, and outputs “1” if the count equals to or exceeds the threshold. The counter 30 counts the time length during which the result of temperature measurement by the temperature measurement circuit 10 equals to or exceeds the threshold.

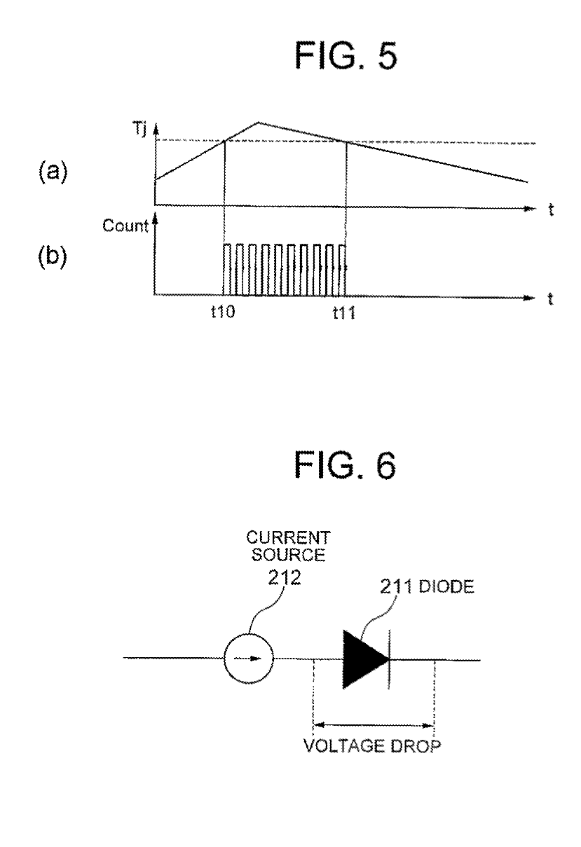

FIG. 5 is a waveform diagram showing waveforms in the LSI of FIG. 4. The result of measurement by the temperature measurement circuit changes, as shown by graph (a) in FIG. 5. The output of comparator 20 assumes “1” at time instant t10 when the result of measurement by the temperature measurement circuit assumes a temperature equal to or exceeding the threshold temperature Tj: The counter 30 starts counting when the output of the comparator 20 assumes “1”, as shown by graph (b) in FIG. 5. The counter continues the count up during the period when the comparator 20 outputs “1”.

The comparator 20 changes the output thereof to “0” at time instant t11 when the result of measurement by the temperature measurement circuit 10 assumes a temperature lower than the threshold temperature Tj. The counter 30 stops the count thereof when the output of the comparator 20 assumes “0”. Thus, the counter 30 counts up during the period from time instant t10 to time instant t11, as shown in graph (b). The count of counter 30 assumes a value corresponding to the time length during which the result of temperature measurement stays at a temperature higher than the threshold temperature. In other words, the count of counter 30 assumes a value corresponding to the time length during which the LSI stays at a temperature equal to or higher than the threshold temperature.

In the present exemplary embodiment, the temperature measurement circuit 10, which is realized to have a smaller occupied area, can be disposed at any arbitrary location without causing an obstacle to the other circuit area. A microprocessor, for example, has different temperatures depending on the location of measurement. In particular, an LSI formed on an SOI substrate has this tendency. Thus, a plurality of temperature measurement circuits are preferably disposed at different locations in the LSI, to measure the temperatures at the different positions.

In general, the long-term reliability or lifetime of the LSI is determined by the time length during which the device elements stay at a temperature that exceeds the threshold temperature. The count of counter 30 represents the time length during which the temperature of device elements exceeds the threshold temperature. Thus, monitoring by using a plurality of counters allows judgment of the long-term reliability of the LSI. In this respect, it is preferable to replace a device element in the LSI when the accumulated count by a counter for the device element exceeds the threshold temperature.

While the invention has been particularly shown and described with reference to exemplary embodiment thereof, the invention is not limited to these embodiments and modifications. As will be apparent to those of ordinary skill in the art, various changes may be made in the invention without departing from the spirit and scope of the invention as defined in the appended claims.

1. A temperature measurement circuit comprising:
a diode including a pair of terminals between which a constant voltage is applied, said diode passing therethrough a current that changes depending on a temperature; and
a temperature detection section that detects the temperature based on the current passing through said diode.

2. The temperature measurement circuit according to claim 1, wherein said constant voltage is a potential difference between a power-source potential and a divided potential obtained by dividing the power-source potential by a specific ratio.

3. The temperature measurement circuit according to claim 1, wherein said temperature detection section comprises: a capacitor that is charged by the current passing through said diode; and a counter that counts a time length from a time instant of start of charging said capacitor and a time instant at which the voltage of said capacitor assumes a specific threshold voltage.

4. A semiconductor integrated circuit comprising:
a diode including a pair of terminals between which a constant voltage is applied, said diode passing therethrough a current that changes depending on a temperature;
a temperature detection section that detects the temperature based on the current passing through said diode; and
a comparator that compares the temperature detected by said temperature detection section with a specific threshold temperature, to output a signal representing whether or not the temperature detected by said temperature detection section exceeds said threshold temperature.

5. The semiconductor integrated circuit according to claim 4, wherein said comparator comprises a counter that counts a time length during which the temperature detected by said temperature detection section exceeds said threshold temperature.

6. The semiconductor integrated circuit according to claim 4, wherein a plurality of groups each including said diode, said temperature detection section and said comparator are provided at respective positions.

7. A temperature measurement method comprising:
applying a constant voltage to a diode passing therethrough a current that changes depending on a temperature; and
detecting the temperature based on the current passing through said diode.

8. The temperature measurement method according to claim 7, wherein said detecting comprises charging a capacitor with the current passing through said diode, and measuring a time length from a time instant of start of charging said capacitor to a time instant at which the voltage of said capacitor assumes a threshold voltage.
